(19) United States
(12) Patent Application Publication
(10) Pub. No.: US 2016/0053937 A1
(43) Pub. Date: Feb. 25, 2016

(54) SUPPORT BRACKET WITH MOVEABLE SIDES AND BACKSTOP

(71) Applicant: UNVERFERTH MANUFACTURING CO., INC., Kalida, OH (US)

(72) Inventor: Dave SMITH, Fort Jennings, OH (US)

(73) Assignee: UNVERFERTH MANUFACTURING CO., INC., Kalida, OH (US)

(21) Appl. No.: 14/823,443

(22) Filed: Aug. 11, 2015

Related U.S. Application Data
(60) Provisional application No. 62/040,119, filed on Aug. 21, 2014.

(51) Int. Cl. F16M 13/02; F16B 2/08

(52) U.S. Cl. CPC F16M 13/022; F16B 2/08

(57) ABSTRACT

An adjustable support bracket configured to support a portion of an object includes a seat configured to support the portion of the object. The seat includes a base plate, a backstop and a first side plate. The adjustable support bracket also includes a mounting portion configured to removably mount the adjustable support bracket to a frame member. The adjustable support bracket further includes a first hinge mechanism and a second hinge mechanism. The first side plate is pivotably coupled to the first hinge mechanism such that it is pivotable between an upper plate position and a lower plate position. The backstop is pivotably coupled to the second hinge mechanism such that it is moveable between an upper backstop position and a lower backstop position.

### CROSS-REFERENCE TO RELATED APPLICATIONS

The present invention claims priority to U.S. Provisional Patent Application No. 62/040,119, filed on Aug. 21, 2014, the entire disclosure of which is incorporated herein by reference.

### BACKGROUND OF THE INVENTION

1. Field of the Invention

The present invention relates generally to a support bracket for a transport wagon used to transport large objects, such as combine headers and other farm equipment. Specifically, the present invention relates to a support bracket including a seat with adjustable sides and backstop.

2. Description of the Related Art

Transport wagons for transporting large farm equipment, such as a cutting header (grain platform, draper, or corn platform) of a combine harvesting machine, are known. A cutting header is the front mechanism of a combine harvesting machine that cuts the crop and feeds it to the harvesting machine for threshing. The cutting header is wider than the body of the harvesting machine and thus, it is difficult and unsafe to transport the entire harvesting machine. Due to its large size, the cutting header is removed from the combine harvesting machine and transported sideways on a transport wagon for safe road travel. Generally support brackets are mounted on the frame of the transport wagon as the mating structure between the transport wagon and the header, and support a portion of one end of the header.

### SUMMARY OF THE INVENTION

According to the present invention, an adjustable support bracket is provided for a transport wagon, used to hold and transport a large object with improvements over the prior art. The adjustable support bracket includes a seat with adjustable side plates and backstop.

According to an embodiment of the present invention, an adjustable support bracket configured to support a portion of an object includes a seat configured to support the portion of the object. The seat includes a base plate, a backstop and a first side plate. The bracket also includes a mounting portion configured to removably mount the adjustable support bracket to a frame member. The bracket further includes a first hinge mechanism and a second hinge mechanism. The first side plate is pivotably coupled to the first hinge mechanism such that it is pivotable between an upper plate position and a lower plate position. The backstop is pivotably coupled to the second hinge mechanism such that it is moveable between an upper backstop position and a lower backstop position.

In another embodiment of the present invention, the mounting portion of the adjustable support bracket includes a strap with a hook, and the hook is configured to be removably coupled with the first hinge mechanism.

In another embodiment of the present invention, the backstop may include a base portion and a backstop plate. The base portion may be pivotably coupled to the second hinge mechanism and the backstop plate may be coupled to the base portion via a coupling member.

### BRIEF DESCRIPTION OF THE DRAWINGS

FIG. 1 illustrates a perspective view of an adjustable support bracket according to an embodiment of the present invention.

FIG. 2 illustrates a perspective view of an adjustable support bracket with the backstop in a lower position according to an embodiment of the present invention.

FIG. 3 illustrates a perspective view of an adjustable support bracket with the side plates in lower positions according to an embodiment of the present invention.

FIG. 4 illustrates a perspective view of an adjustable support bracket with the backstop plate removed according to an embodiment of the present invention.

FIG. 5 illustrates a perspective view of an adjustable support bracket with the backstop in a lower position and the backstop plate removed according to an embodiment of the present invention.

FIG. 6 illustrates a perspective view of an adjustable support bracket with the backstop in a lower position according to an embodiment of the present invention.

FIG. 7 illustrates a perspective view of an adjustable support bracket with the side plates in lower positions according to an embodiment of the present invention.

FIG. 8 illustrates a perspective view of an adjustable support bracket with the backstop plate removed according to an embodiment of the present invention.

FIG. 9 illustrates a top view of an adjustable support bracket according to an embodiment of the present invention.

FIG. 10 illustrates a perspective view of adjustable support brackets coupled to the frame of a transport wagon according to an embodiment of the present invention.

### DETAILED DESCRIPTION OF THE PRESENT INVENTION

While the present invention may be embodied in many different forms, a number of illustrative embodiments are described herein with the understanding that the present disclosure is to be considered as providing examples and not intended to limit the invention to the preferred embodiments described and/or illustrated herein.

In an embodiment of the present invention, the adjustable support bracket includes side plates and a backstop which may be moved between lower and upper positions, respectively. The support bracket may be mounted to a support member, such as a member of a frame, via a mounting portion. The seat of the support bracket is configured to support a portion of a large object.

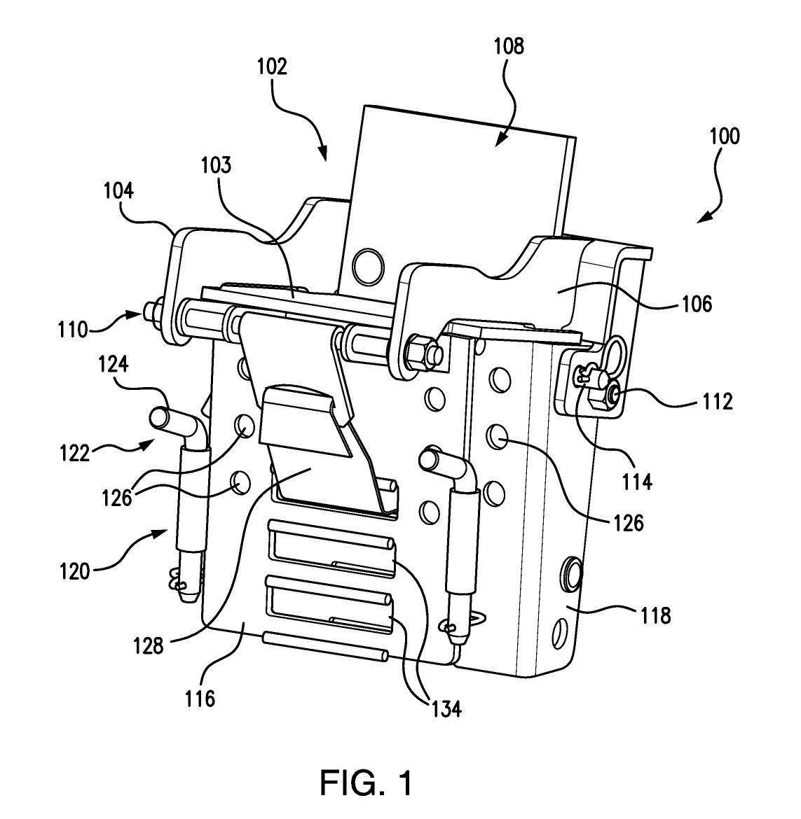

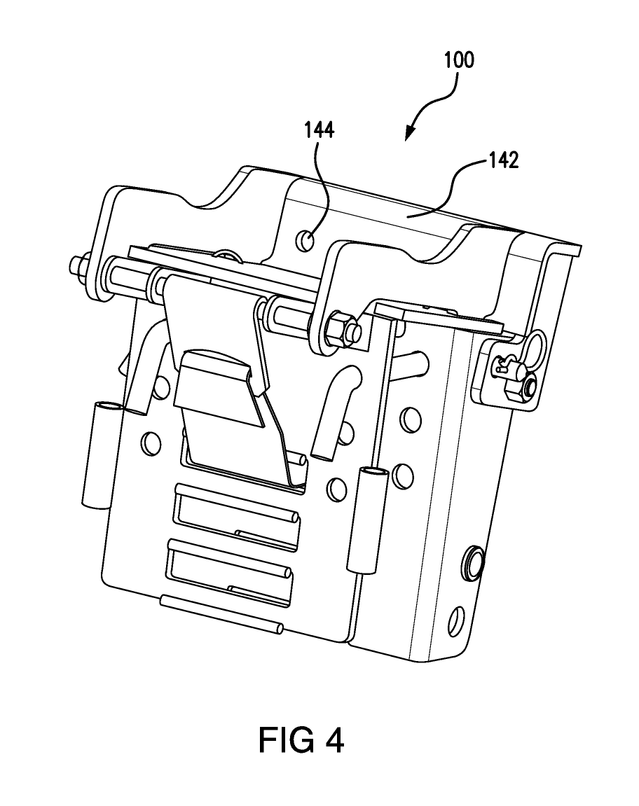

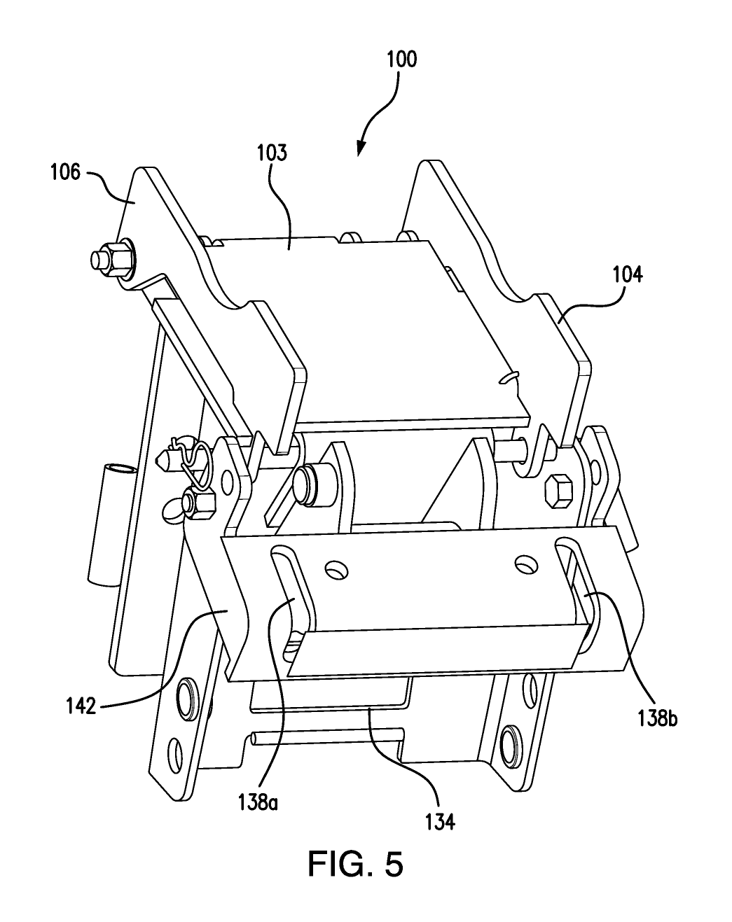

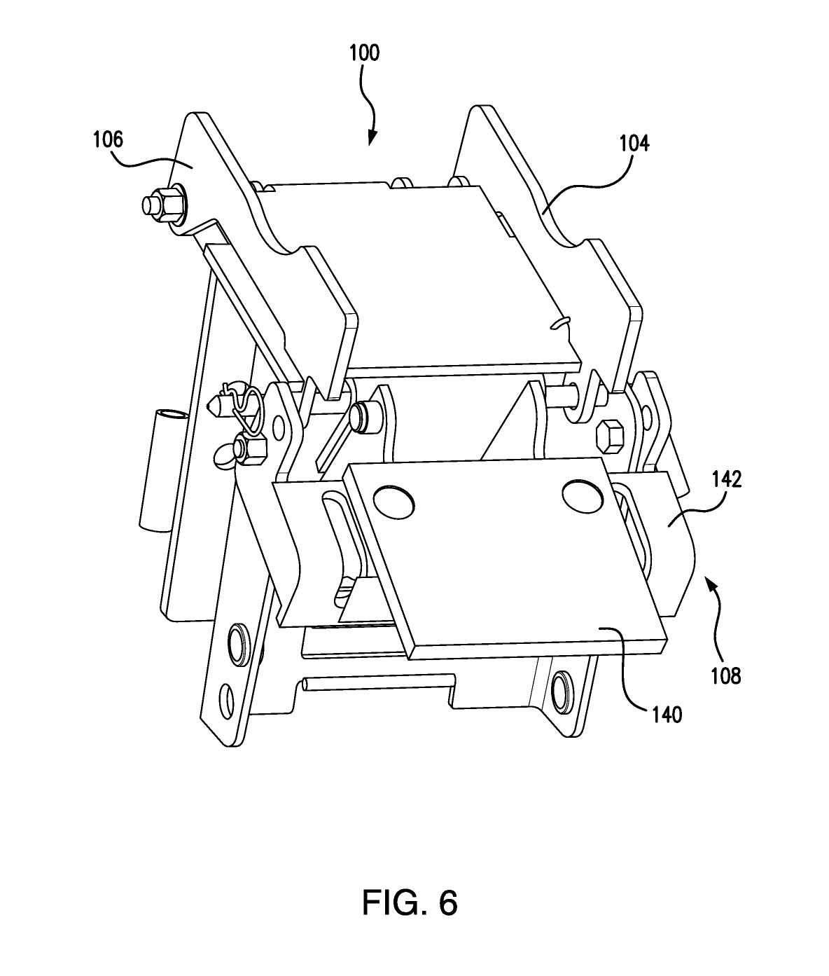

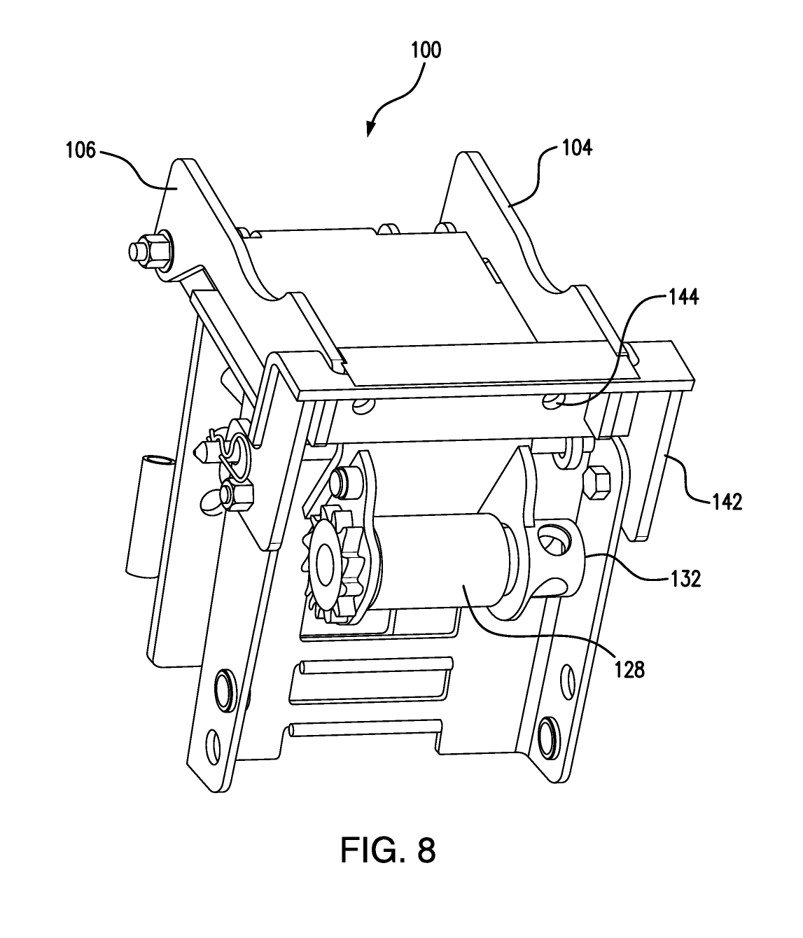

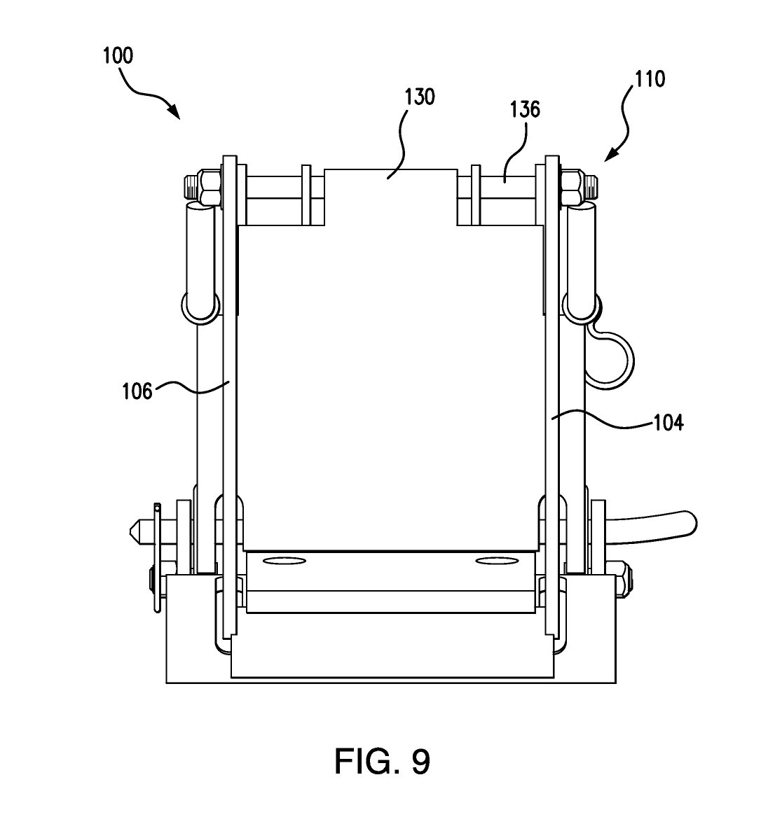

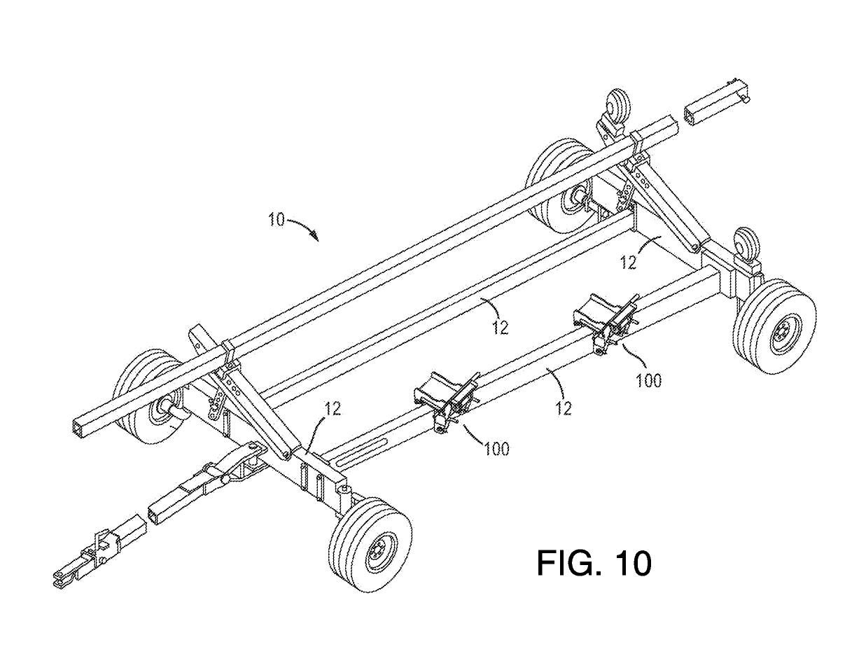

FIGS. 1-9 illustrates an adjustable support bracket 100 according to an embodiment of the present invention. The adjustable support bracket 100 may include an adjustable seat 102 and a mounting portion 120. The seat is configured to support a portion of a large object to be secured thereto. The mounting portion 120 is configured to allow the adjustable support bracket 100 to be removably coupled with the frame of the transport wagon without separate tools and adjustably positioned along the frame of the transport wagon (as shown in FIG. 10). The mounting portion 120 is described in greater detail in co-owned U.S. application Ser. No. 13/036,215, the entirety of which is herein incorporated-by-reference. The angled adjustable seat 102 and the mounting portion 120 can be welded together to form a shape based on the frame of the transport wagon.

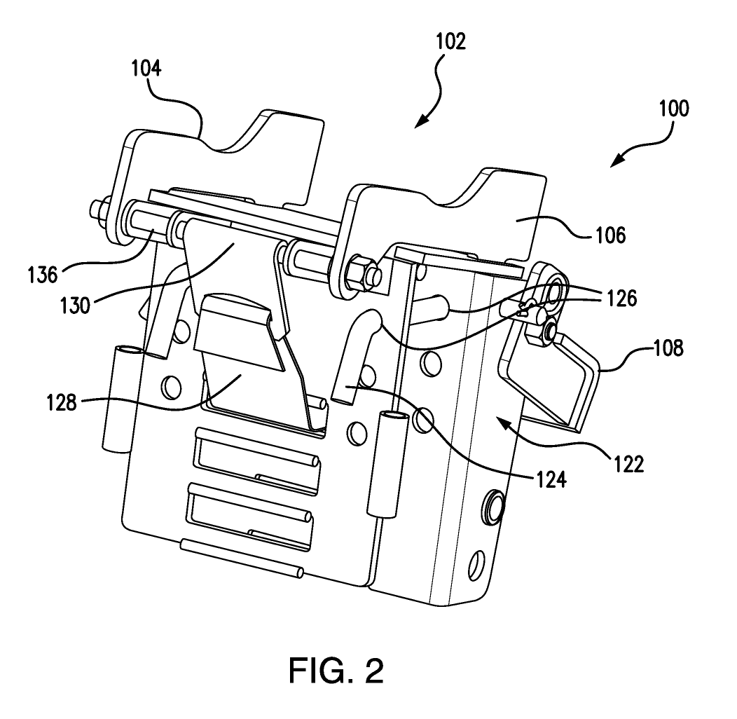

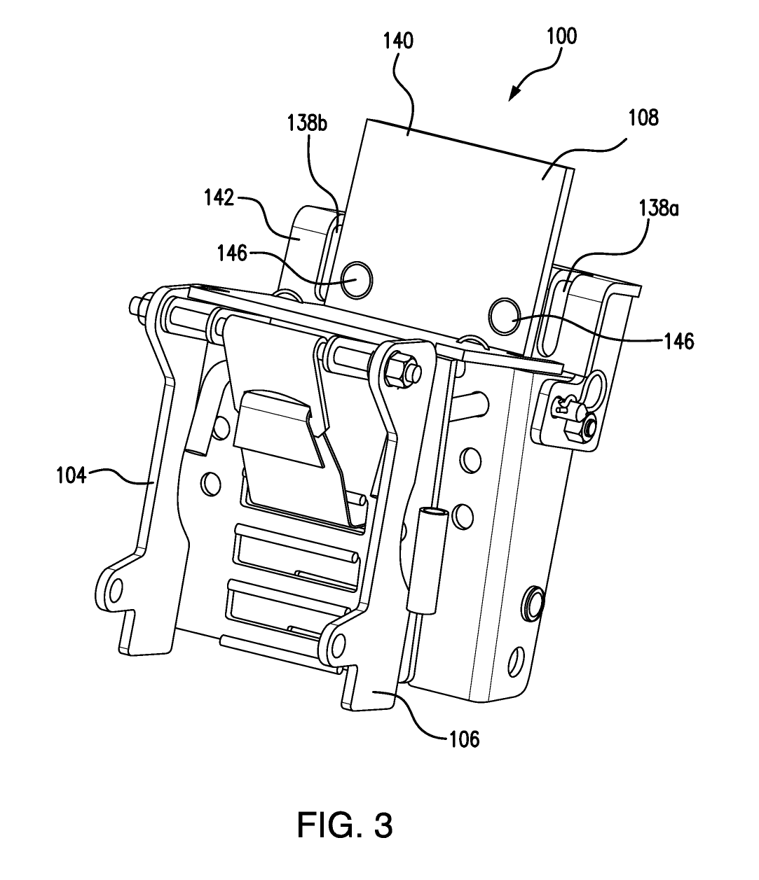

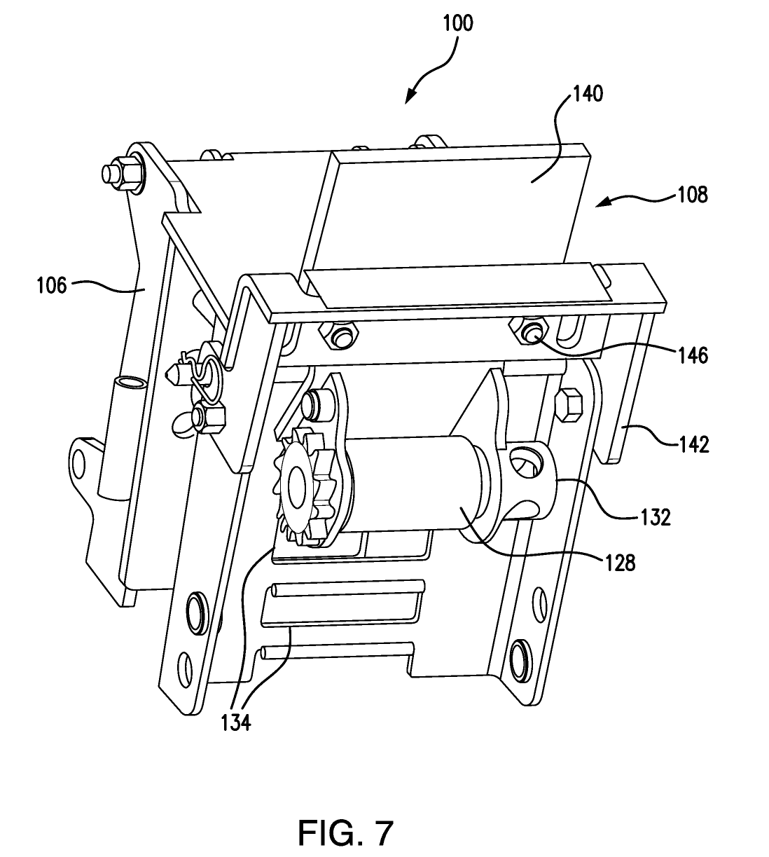

The angled adjustable seat 102 includes a base plate 103, at least one side plate 104, 106, and a backstop 108. The base plate 103 may be fixed to the mounting portion 120. In an embodiment of the present invention, the seat 102 includes two side plates 104, 106, although it may include more plates (e.g., three plates). The side plates 104, 106 may be pivotably coupled to a first hinge member 110 and formed of various shapes, e.g., curved to provide a specific contour to better receive the object to be transported. In an embodiment of the present invention, each side plate 104, 106 includes an opening, and the first hinge member 110 is received within the opening such that the side plate 104, 106 is pivotably coupled to the first hinge member 110. The side plates 104, 106 may pivot about the first hinge member 110 such that they move relative to the base plate 103 between a lower position (as shown in FIGS. 3 and 7) and an upper position (as shown in FIGS. 1, 2, 4-6 and 8-9). The first side plate 104 may move independently of the second side plate 106, e.g., the first side plate 104 may be moved to a lower position while the second side plate 106 is in an upper position and visa-versa. The backstop 108 may be pivotably coupled to a second hinge member 112, and the backstop 108 may be locked in position or allowed to pivot by positioning a locking member 114 in a locked or unlocked position. When the backstop 108 is free to pivot, the backstop 108 is pivotable between an upper position (as shown in FIGS. 1, 3-4 and 7-9) and a lower position (as shown in FIGS. 2 and 5-6).

The mounting portion 120 may include a height adjustment portion 114 and two leg members 116, 118 welded to the adjustable seat 102, specifically to the base plate 103. The first leg 116 and the second leg member 118 define an opening which may receive a frame member 12 of a transport wagon 10, as shown in FIG. 10. The height adjustment portion 114 includes at least two height adjusting pins 124 and a plurality of height adjusting holes 126. The pins 124 may be positioned in holes 126 to adjust the height of the seat 102 relative to the frame member 12 to which it is mounted. When not in use, the pins 124 may be placed in holders on the bracket 100. The mounting portion 120 also includes a flexible strap 128 including a hook 130 at an end and coupled to a winch 132 at the opposite end. The flexible strap 128 may be fed through slots 134 in the first and second legs 116, 118, and the hook may be coupled to the shaft 136 of the first hinge member 110.

The backstop structure 108 includes openings 138a, 138b, a backstop plate 140 and a backstop base 142. The openings 138a, 138b are configured to receive the side plates 104, 106 when the side plates are in an upper position. The backstop structure 108 includes at least as many openings 138a, 138b as side plates 104, 106 in the bracket 100, e.g., if there are three side plates then there are at least three openings. The backstop plate 140 projects higher than the backstop base 142 when it is coupled to the base 142. The backstop base 142 is pivotably coupled to the second hinge member 112. In an embodiment of the present invention, the backstop base 142 may include at least one opening, and the second hinge member 112 is received within the opening such that the backstop base 142 is pivotably coupled to the second hinge member 112. The backstop plate 140 is removably coupled to the backstop base 142. In an embodiment, the backstop plate 140 is coupled to the backstop base 142 by engaging the backstop base openings 144 with backstop plate couplings 146. The backstop base couplings 146 may be fixed to the backstop plate 140 or the couplings may be separate components, e.g., bolts, and the backstop plate 140 may include openings to receive the couplings.

From the above it will be appreciated that the adjustable support bracket of the present invention includes a seat for supporting a portion of an object and including adjustable side plates and backstop. It will also be appreciated that various changes can be made to the system without deviating from the spirit and scope of the appended claims.

We claim:

1. An adjustable support bracket configured to support a portion of an object, the adjustable support bracket comprising:
a mounting portion having a mounting end and a support end and having a first horizontal pivot point defining a first horizontal axis and a second horizontal pivot point defining a second horizontal axis, wherein the first and second horizontal axes are in a spaced-apart relationship and wherein the mounting portion is configured to removably mount the adjustable support bracket to the frame at the mounting end of the mounting portion; and
a seat having a base plate coupled to the support end of the mounting portion, a first side plate pivotably coupled to the first horizontal pivot point such that the first side plate is pivotable relative to the first horizontal axis between an upper plate position and a lower plate position, and a backstop pivotably coupled to the second horizontal pivot point such that the backstop is pivotable relative to the second horizontal axis between an upper backstop position and a lower backstop position.

2. The adjustable support bracket of claim 1, wherein the mounting portion includes a strap with a hook, and the hook is configured to be removably coupled with the first hinge member.

3. The adjustable support bracket of claim 1, the backstop includes a base portion and a backstop plate.

4. The adjustable support bracket of claim 3, wherein the base portion is pivotably coupled to the second horizontal pivot point and the backstop plate is coupled to the base portion via a coupling member.

5. The adjustable support bracket of claim 1, further comprising a second side plate, wherein the second side plate is pivotably coupled to the first horizontal pivot point such that it is pivotable relative to the first horizontal axis between an upper second plate position and a lower second plate position.

6. The adjustable support bracket of claim 1, further comprising a locking member moveable between a locked position in which the backstop is prevented from pivoting about the second horizontal axis and an unlocked position in which the backstop is allowed to pivot about the second horizontal axis.

7. The adjustable support bracket of claim 1, wherein the first side plate is curved to provide a contour to receive the portion of the object to be supported.

8. The adjustable support bracket of claim 5, wherein the first side plate and the second side plate are independently pivotable about the first horizontal axis.

9. The adjustable support bracket of claim 1, wherein the backstop further includes a first opening configured to receive the first side plate when the first side plate is in the upper plate position.

10. The adjustable support bracket of claim 1, wherein the first horizontal pivot point comprises a first hinge mechanism and the second horizontal pivot point comprises a second hinge mechanism.
